(19) United States
(12) Patent Application Publication
(10) Pub. No.: US 2007/0012535 A1
(43) Pub. Date: Jan. 18, 2007

(54) Laminated damper

(76) Inventor: Alfred Paul Matheny, Jupiter, FL (US)

Correspondence Address: Paul Matheny;Florida Turbine Technologies, Inc., Suite 301, 140 Intracoastal Pointe Drive, Jupiter, FL, 33477, US

(21) Appl. No.: 11/183,153

(22) Filed: Jul. 15, 2005

(51) Int. Cl. F16F 9/12

(52) U.S. Cl. 188/378; 188/266

(57) ABSTRACT

A laminated damper intended to be used to support and dampen vibrations in a bearing, where the damper includes a plurality of laminates of a flexible yet rigid material, the damper having an L-shape proximal end and a bearing support surface on the distal end, and where the distal end is spaced far enough from the proximal end that a vibration produces a relative sliding motion between laminates that the friction developed produces the damping of the vibration. The preferred embodiment of the laminated damper includes one or more layers of a viscoelastic material sandwiched between a plurality of supporting laminates, where a vibration flexes the supporting laminates and creates a shear force in the viscoelastic layer between the laminates. The shear force in the viscoelastic layer dampens the vibration.

### TECHNICAL FIELD

The present invention relates to an apparatus for reducing vibrations in a bearing, and more particularly to a support member for the bearing in which the support member includes two or more layers of a flexible but rigid material, or two or more flexible but rigid layers with a layer of a viscoelastic material sandwiched between to dampen vibrations occurring in the bearing.

### BACKGROUND OF THE INVENTION

Roller bearings are used in many instances, and each bearing will have a number of natural frequencies based upon the rotational speed of the bearing in which the vibration is high. The vibration can become excessive and damage or destroy the bearing. Viscoelastic materials have been used in bearings to provide a damping capability. U.S. Pat. No. 6,536,953 issued to Cope et al on Mar. 25, 2003 shows a bearing mounting system and method that reduces vibration using a singular annular elastomeric member contained in a substantially enclosed area that includes open area free of elastomeric material. A bearing raceway surface and an adjacent support surface are spaced apart by a predetermined radial gap. The enclosed cross-sectional area is bounded by features on the bearing raceway surface and the supporting surface that could be either the rotating roll or a support shaft. The enclosed area has a depth and a width and includes the radial gap. The viscoelastic deformation of the elastomeric member contained in this enclosed area in conjunction with the amount of open area in the enclosed area, provides a dual stiffness system that reduces or eliminates the excessive vibration that occurs in chucks for textile fiber windups or similar systems, when there is relative movement to reduce the radial gap and the enclosed area containing the radial gap.

U.S. Pat. No. 6,540,407 issued to Van Dine et al on Apr. 1, 2003 shows a rolling element bearing arrangement includes an inner raceway with a curved outer surface facing in one lateral direction, an outer raceway with a curved inner surface facing in the opposite lateral direction, an array of rolling elements such as balls engaging the curved surfaces of the inner and outer raceways, a retaining ring in which the array of balls is received, and a retaining ring stabilizer urging the retaining ring in a lateral direction with respect to one of the raceways to inhibit vibration of the components. In addition, a vibration inhibiting outer ring member which may contain a heavy metal or a resilient material, is retained against the outer surface of the outer raceway by a composite wrap which may be a fiber-reinforced organic or inorganic polymer composite made by a dry lay-up, resin transfer molding, wet filament winding or pre-impregnated filament winding technique.

U.S. Pat. No. 5,816,712 issued to Brown et al on Oct. 6, 1998 shows elastomeric cartridges for attenuation of bearing-generated vibration in electric motors in which the inventive cylindrical cartridges are installed in machinery for purposes of isolating vibration of conventional rolling element bearings from major machinery components. Two inventive cartridges are concentrically coupled with a rolling element bearing, one cartridge fitting circumferentially inside the bearing's inner ring, the other cartridge fitting circumferentially outside the bearing's outer ring. Each inventive cartridge comprises inner and outer concentric cylindrical metallic pieces and an intermediate filling which includes two lateral circumferential elastomeric bands separated by a medial circumferential air gap. The inventive cartridges can be inexpensively fabricated and can be permanently integrated with existing machinery.

One of the major disadvantages of the above described prior art viscoelastic dampers are that the vibration in the damping material is compressive. In the prior art dampers, the damper material is located directly above the bearing that produces the vibration. The full use of the damping capability of a viscoelastic material is not used.

FIG. 8 shows a typical Prior Art viscoelastic damper for support of a bearing. The bearing would be supported just below the lower metallic layer in the damper. The viscoelastic material in the damper is shown in FIG. 8 in cross hatching, while the two metallic layers above and below the viscoelastic layer are not hatched. The arrows represent the vibration forces and directions. As can be seen in FIG. 8, the vibrations act to compress the viscoelastic material. In this Prior Art arrangement, a large amount of movement in the bearing support layer is required to produce a large amount of movement in the viscoelastic material to produce the damping affect in this particular material.

It is therefore an objective of the present invention to provide for a damper device in which a large amount of damping is produces with very little movement of the device. This objective is accomplished by using a viscoelastic material as the damping material, and offsetting the rigid support of the damper from the location on which the vibration acts in order to produce a shear stress in the damping material, and therefore providing the most damping capability with the least amount of movement.

### SUMMARY OF THE INVENTION

The present invention is a laminated damper having a plurality of laminated layers of a flexible but rigid material extending along a certain length, one end of the damper having a mounting means to secure the damper to a rigid support, the other end of the damper having a vibrating contact surface, where a main feature of the present invention is that the spacing between damper mounting means and the vibrating contact surface is far enough apart to produce a shear force between laminated layers resulting in friction that provides the damping affect.

Another embodiment of the present invention includes one or more layers of a viscoelastic material sandwiched between two or more of the flexible but rigid layers to form a damper, where the shear force between the flexible but rigid layers produces a shear force in the viscoelastic material which acts to dampen the vibrations.

In still another embodiment of the present invention, the damper is used to dampen vibrations in a bearing, where the bearing is in contact with the damper at one end while the bearing support is secured to a casing at an opposite end in order to allow for movement of the flexible but rigid layers to create a shear force in the viscoelastic layer sandwiched between the metallic layers, and therefore producing a large amount of damping with a small amount of movement of the bearing support. In one embodiment, one layer of viscoelastic material is used, while in a second embodiment two layers of viscoelastic material is used. Another embodiment includes slots in the bearing support to control the rigidity of the bearing support, while in still another embodiment the bearing support is formed of four fingers extending to an open end of the bearing support to allow for control of the rigidity.

### BRIEF DESCRIPTION OF THE DRAWINGS

FIG. 1 shows a side view of a cross section of a damper having two flat layers of a flexible but rigid material;

FIG. 2 shows a front view of the damper in FIG. 1;

FIG. 3 shows a side view of a cross section of a damper having two flat layers of a flexible but rigid material, and a layer of a viscoelastic material sandwiched between the two rigid layers;

FIG. 4 shows a front view of the damper in FIG. 3;

FIG. 5 shows a side view of a cross section of a damper used in a bearing with two layers of a viscoelastic material sandwiched between three flexible but rigid layers that form a bearing support;

FIG. 6 shows a layer of dampening material in a non-flexed position, and a layer of dampening material in a flexed position superimposed on the non-flexed position;

FIG. 7a shows the non-flexed position of the damping layer;

FIG. 7b shows the flexed position of the damping layer with the shear forces acting on the metallic layers;

FIG. 8 shows the Prior Art viscoelastic dampers in which the damping force is applied normal to the surfaces of the layers such that no shear force is applied to the damping material;

FIG. 9 shows a side view of a cross section of a bearing damper having a layer of viscoelastic material sandwiched between two flexible but rigid layers, where the viscoelastic layer ends at the L-shape portion of the damper;

FIG. 10 shows a side view of a cross section of a bearing damper having a layer of viscoelastic material sandwiched between two flexible but rigid layers, where the layers are angled from an axis of rotation of the bearing;

FIG. 11 shows a side view of a cross section of a bearing damper having a layer of viscoelastic material sandwiched between two flexible but rigid layers, where the viscoelastic layer thickness varies from the bearing end to the mounting end;

FIG. 12 shows a front view of the bearing damper of FIG. 5;

FIG. 13 shows a 3 dimensional view of a bearing damper having slots extending along the bearing support portion of the damper;

FIG. 14 shows a 3 dimensional view of a bearing damper having slots extending to the bearing support end of the damper and forming fingers.

### DETAILED DESCRIPTION OF THE INVENTION

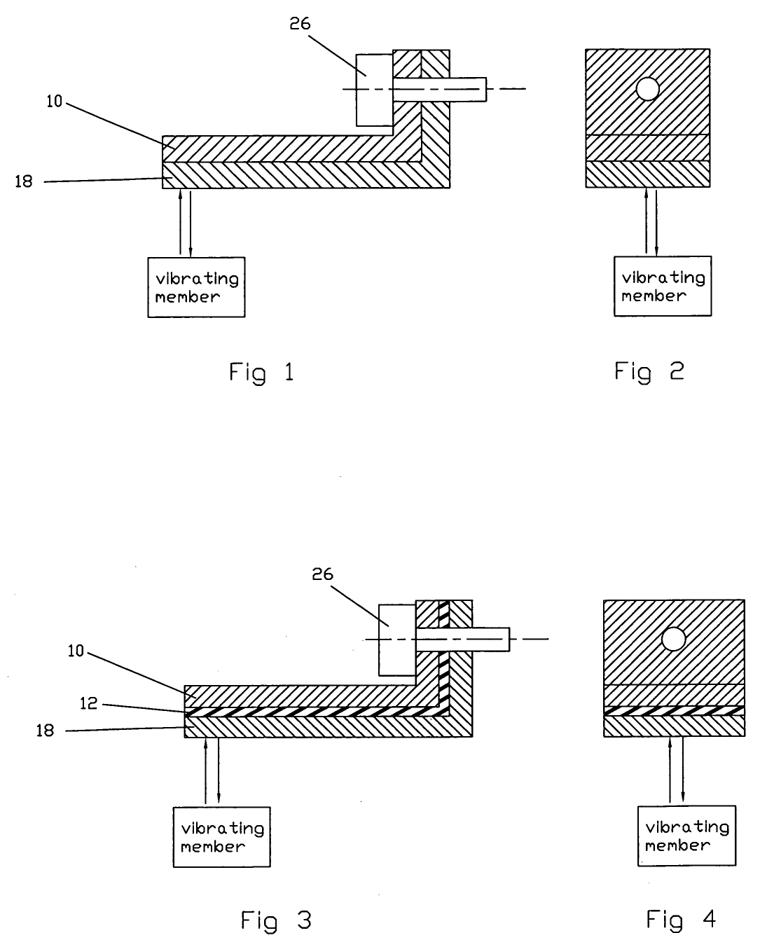

A damper of the present invention is shown in FIGS. 1 and 2 in which two laminates are secured together by a bolt 26, the laminates including an outer layer 10 and an inner layer 18. The layers are placed in contact with each other along a contact face. The damper has a certain length for the purpose that will be described below. A proximate end of the damper includes an L-shape portion with a bolt hole passing through both layers. A bolt 26 is used to secure the damper to a casing or other rigid and relatively non-vibrating support. The distal end of the damper includes the vibrating contact surface or face of the damper. The outer lay 10 and the inner layer 18 are made of any material that is both flexible and rigid in that the layers are flexible enough to allow the vibrations to bend the layers, and rigid enough to support the vibrating source such as a bearing.

The damping is produced by the frictional rubbing of adjacent metallic layers. The embodiment of FIG. 1 can have two or more layers of the metallic material. The contact surfaces of the support layers can even be treated to increase the friction developed between sliding layers to increase the damping affect. Laser etching of the contact surfaces is one process for increasing the friction. Any process that would remove the smooth finish typically found on the surface of rolled or stamped metal would increase the friction. A smooth contact surface is not desirable for dampening the vibrations when no viscoelastic layer is used.

A preferred embodiment of the present invention is shown in FIGS. 3 and 4. The preferred embodiment differs from the embodiment shown in FIG. 1 in that a layer of a viscoelastic material 12 is sandwiched between the outer 10 and inner 18 layers of the flexible but rigid material. An L-shape extension of the outer and inner layers forms the damper mounting portion in which a bolt hole is formed. In this embodiment, the viscoelastic layer extends into the L-shape layers. The use of the viscoelastic material in this embodiment improves the damping ability of the laminates due to the material characteristics. The flexing of the inner and outer layers 18 and 10 creates a shear force in the viscoelastic layer which provides more damping that using only friction as disclosed in the FIG. 1 embodiment. The thickness of the viscoelastic layer is typically in the range of 0.001 inches to 0.005 inches depending upon the damping characteristic. However, the thickness can be of any value as long as the damping affect is adequate.

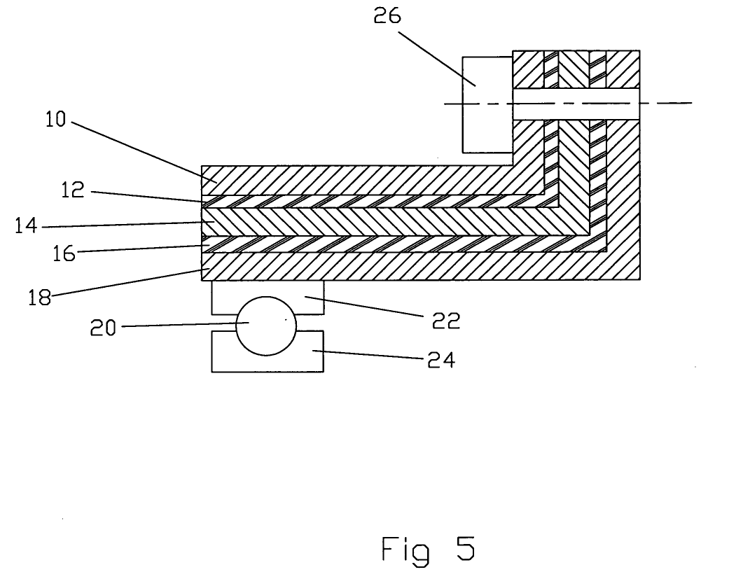

The viscoelastic damper described above is intended to be used as a damper for a bearing. FIG. 5 shows the damper for use in a bearing, where the damper includes 3 layers of a flexible yet rigid laminate with 2 layers of a viscoelastic material sandwiched between the laminates. The bearing support in FIG. 5 and includes an outer metallic layer 10, a middle metallic layer 14, an inner metallic layer 18, an outer viscoelastic layer 12, and an inner viscoelastic layer 16. The three metallic layers sandwich the two viscoelastic layers to form the bearing support. The metallic layers and the viscoelastic layers have an L-shape cross section in order to provide for a radial extending portion for mounting the bearing support to a casing. Bolt holes 28 having a bolt 26 passing through are used to secure the bearing support to a casing. A ball bearing formed of an inner race 24, an outer race 22, and a ball 20 is mounted within the inner layer 18.

In use, the metallic layers are numerous enough and thick enough to provide for a rigid bearing support. The viscoelastic layer or layers are of such thickness to provide damping, yet allow for the metallic layers to maintain a rigid support structure. If the viscoelastic layer is too thin, the damping affect will not be enough. If the viscoelastic layer is too thick, the rigidity of the metallic layers will be lost or not affective. The number of layers of viscoelastic material can vary from one to any number desired in order to provide the desired damping and rigidity of the bearing support.

The material for the metallic layers in the bearing support is not limited to metals. They can be plastics or ceramics as long as they can support the bearing. The bearing can be any of the well known bearings, such as ball and roller bearings, antifriction bearings, or friction bearings. The viscoelastic material can be any of the well known viscoelastic materials as long as they can be secured in place between the metallic layers. Viscoelastic materials can be polymeric materials made up of long molecular chains such as organic chains of hydrogen and carbon, or of glassy materials such as inorganic oxides of which the glass is composed of different lattice geometries like sodium-silicate glass.

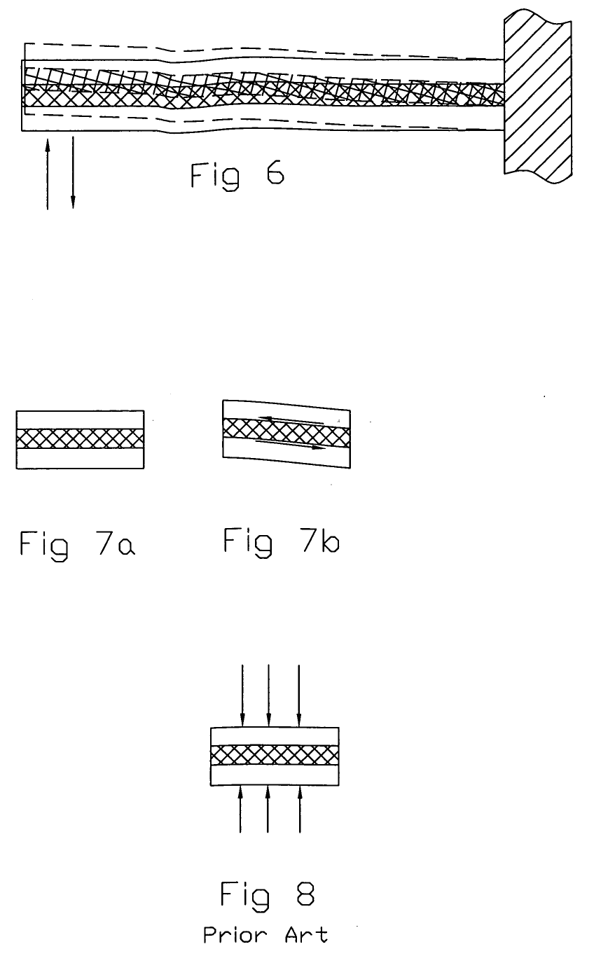

FIGS. 6, 7a, 7b, and 8 are used to show the principal behind the present invention and how the present invention differs from those found in the prior art. The Prior Art damper shown in FIG. 8 produces only a compressive force to the damping material as discussed above in the Background section of this disclosure. FIG. 6 shows how the present invention differs from the Prior Art devices. The bearing support is secured to a casing 40 on one end of the support, and the bearing vibrations act on the opposite end of the support as shown by the arrows. A spring board effect takes place when the vibrations from the bearing act on the one end of the bearing support, where the metallic layers actually slide with respect to each other. Since the damping material is fixed to the layers, a shear force develops in the damping material due to the spring board effect in the metallic layers of either side of the damping layer as represented in FIG. 7a (unflexed) and FIG. 7b (flexed). Only a small displacement of the free end of the bearing support due to the vibration will produce a large shear force in the damping material. Thus, in the present invention a larger damping is produced with a smaller amount of movement that the Prior Art viscoelastic dampers can produce.

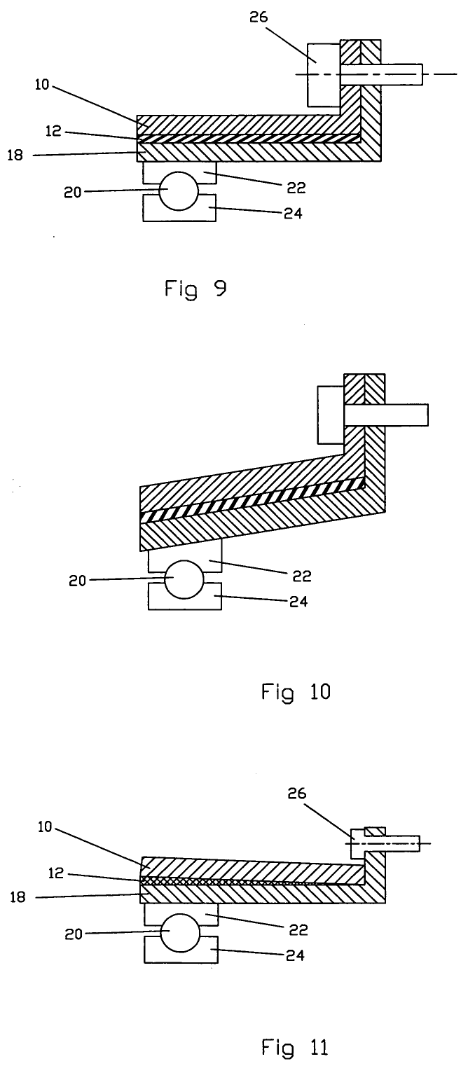

FIG. 9 shows an additional embodiment of the viscoelastic damper in which the viscoelastic layer does not extend into the L-shape portion of the outer and inner layers 10 and 18. FIG. 10 shows an embodiment of the viscoelastic damper in which the outer and inner layers 10 and 18 are not aligned with the rotational axis of the bearing. The outer and inner layers 10 and 18 could be offset from the longitudinal axis from any angle greater than zero degrees to an angle less than 45 degrees. The FIG. 11 embodiment of the viscoelastic damper shows the viscoelastic layer with a varying thickness.

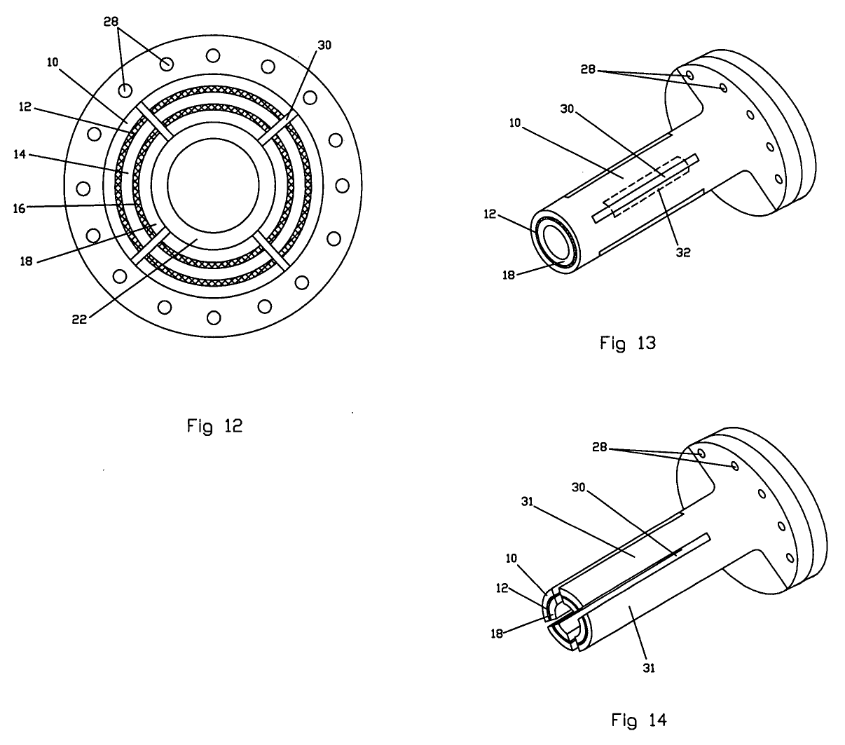

FIG. 12 shows a front view of the damper shown in FIG. 5 but with slots formed in the laminates and viscoelastic layers. The slots improve the flexibility of the damper. As seen in FIGS. 12 and 13, the longitudinally extending portion of the bearing support—on which the actual bearing is mounted—includes four slots 30 extending along the longitudinal direction. The slots can vary in number, width and length in order to vary the damping affect of the bearing support. Slot 32 shown in FIG. 13 with hidden lines is shorter and thicker than the slots 30 shown in continuous lines. Slots 30 would provide for a more rigid bearing support than would the wider and shorter slots 32. The thickness of the viscoelastic layers can also be varied to affect the damping characteristics. The relative size of the bearing support portions shown in FIGS. 12 and 13 are not to be considered true to scale. The diameter of the annular portion on which the bearing makes contact with is much larger than shown in these figures. Also, the length of the cylindrical portion of the bearing support shown in FIG. 13 is shorter in relation to the disc portion having the bolt holes therein.

FIG. 14 shows an alternate embodiment of the damper, where the slots extend all the way through the end of the cylindrical portion to form fingers 31. The bearing support in FIG. 14 has four fingers 31 separated by four slots 30. Each finger 31 includes an inner metallic layer 18, an outer metallic layer 10, and a viscoelastic layer 12 sandwiched between the metallic layers. In the FIG. 14 embodiment, only one viscoelastic layer is used. However, two or more viscoelastic layers can be sandwiched between three or more metallic layers. As in the first embodiment, the width of the slots can vary to affect the damping characteristic of the bearing support. Varying the thickness of the viscoelastic layer will also affect the damping characteristic. The support layers are both shown extending along a direction substantially parallel to the rotational axis of the bearing. However, the support layers, especially for the ones that form fingers as described with respect to the FIG. 14 embodiment, can be oriented at any angle from zero degrees from the rotational axis of the bearing to 45 degrees from the rotational axis of the bearing and still provide for flexing of the layers to produce the damping affect described in the present invention, with or without the viscoelastic layers.

I claim the following:

1. A laminated damper, comprising:
An outer layer;
An inner layer;
Mounting means to secure the damper to a non-vibrating member located on a proximal end of the damper; and,
A contact surface on one of the layers to receive a vibration, the contact surface being located near a distal end of the damper, the proximal end being spaced from the distal end such that the vibration produces a sliding movement between a contact surface of the layers to dampen the vibration.

2. The laminated damper of claim 1, and further comprising:
A layer of a viscoelastic material is sandwiched between the outer and inner layers, wherein the vibration produces a shear force in the viscoelastic layer that acts to dampen the vibration.

3. The laminated damper of claim 2, and further comprising:
The viscoelastic layer having a thickness from 0.001 inches to 0.005 inches.

4. The laminated damper of claim 1, and further comprising:
The contact surface of the inner and outer layers having a roughened surface.

5. The laminated damper of claim 1, and further comprising:
The mounting means comprising a L-shape extension of the inner and the outer layers; and,
A bolt hole located in the L-shape extension sized to receive a bolt to secure the damper to the non-vibrating member.

6. The laminated damper of claim 1, and further comprising:
The layers being aligned in a direction substantially at 90 degrees from a direction that the vibration acts on the vibration contact surface.

7. The laminated damper of claim 1, and further comprising:
The layers being aligned in a direction substantially at 45 to 90 degrees from a direction that the vibration acts on the vibration contact surface.

8. The laminated damper of claim 1, and further comprising:
A middle layer positioned between the inner and the outer layers, both surfaces of the middle layer having a friction contact surface to engage the other two layers to produce friction damping.

9. The laminated damper of claim 2, and further comprising:
A middle layer positioned between the inner and the outer layers; and,
A second layer of a viscoelastic material positioned between the three layers, wherein the vibration produces a shear force in the viscoelastic layers that acts to dampen the vibration.

10. The laminated damper of claim 1, and further comprising:
The layers having a circular cross sectional shape.

11. The laminated damper of claim 5, and further comprising:
The layers having an annular cross section shape and extending from the L-shape extension to form a substantially cylindrical shaped body.

12. The laminated damper of claim 11, and further comprising:
The cylindrical shaped body having a plurality of slots therein.

13. The laminated damper of claim 12, and further comprising:
The slots extending to the distal end of the damper to form a plurality of fingers.

14. The laminated damper of claim 11, and further comprising:
A plurality of layers of a viscoelastic material sandwiched between a plurality of layers of a flexible but rigid material.

15. The laminated damper of claim 1, and further comprising:
The vibration contact surface supports a bearing outer race, and the damper acts to dampen vibrations in the bearing.

16. A process for damping vibration, the process comprising the steps of:
Providing for a plurality of laminates having a rigidity to support a vibrating object;
Securing the laminates to a non-vibrating support at a proximal end of the laminates; and,
Spacing the proximal end from the distal end such that a vibration applied at the distal end produces a relative sliding between the laminates such that friction occurs to dampen the vibration.

17. The process for damping vibration of claim 16, and further comprising the step of:
Sandwiching a layer of a viscoelastic material between the plurality of supporting laminates such that a vibration applied near the distal end produces a shear force in the viscoelastic material to dampen the vibration.

18. The process for damping vibration of claim 16, and further comprising the step of:
Proving for an L-shaped extension on the proximal end of the supporting laminates for securing the laminates to a non-vibrating support.

19. The process for damping vibration of claim 17, and further comprising the step of:
Providing for two or more layers of the viscoelastic material to be sandwiched between three or more supporting laminates.

20. The process for damping vibration of claim 16, and further comprising the step of:
Providing for a plurality of slots in the supporting laminates to increase the flexibility of the supporting laminates.

21. The process for damping vibration of claim 20, and further comprising the step of:
Providing for the slots to extend through the distal end to form a plurality of fingers in the supporting laminates.

22. The process for damping vibration of claim 17, and further comprising the step of:
Providing for the layer of viscoelastic material to have a thickness of 0.001 inches to 0.003 inches.
